(19) United States
(12) Patent Application Publication
(10) Pub. No.: US 2002/0098468 A1
(43) Pub. Date: Jul. 25, 2002

(54) Method for constructing and teaching a curriculum

(75) Inventors: Archie Barrett, Georgetown, TX (US); Martin Mascarenas, Round Rock, TX (US)

Correspondence Address: Alan R. Thiele, JENKENS & GILCHRIST, PC, 1445 Ross Avenue, Suite 3200, Dallas, TX, 75202-2799, US

(73) Assignee: Avatar Technology, Inc.

(21) Appl. No.: 09/767,979

(22) Filed: Jan. 23, 2001

(51) Int. Cl. G09B 7/00

(52) U.S. Cl. 434/322

(57) ABSTRACT

A method of constructing and teaching a curriculum to a student which includes primary course components and buckets of test questions which are mapped to at least one of the primary course components. A student takes the course and completes a primary review exercise which includes selected test questions. The exercise is scored according to pre-determined thresholds to determine whether the student passes or fails the curriculum, or begins the Adaptive eLearning Process. If the student enters the Adaptive eLearning Process, the student receives automatically generated content-based Adaptive eLearning Components based upon the primary course components which are mapped to the questions which the student missed. These components may be personalized by the instructor. The student studies the Adaptive eLearning Components at pre-determined intervals prior to completing the Adaptive Component Review Exercise. The Adaptive eLearning Review Exercise tests the student on all primary course components which were mapped to the student's missed questions. The exercise includes questions from the same buckets as the student's missed questions as well as other buckets which are also mapped to those primary course components. The student's performance on the Adaptive Component Review Exercise is scored relative to pre-determined thresholds. Based on the student's accurately answered percentage score, the student will either pass the curriculum or continue the Adaptive eLearning Process. If they do not pass, then a new Adaptive eLearning Component is generated based on the questions they missed. In this way, the student continues studying and learning from the Adaptive eLearning Components until they pass the Review Exercise. If the failing and passing thresholds are set to 0 and 100, respectively, then each student will continue studying Adaptive eLearning Components until they have scored 100% on the questions covering all of the material. In this way, each student will master all of the concepts.

### BACKGROUND OF THE INVENTION

1. Technical Field

This invention relates generally to learning methods and more specifically to personalized learning methods that assess and re-adapt the content to the needs of an individual student.

2. History of Related Art

Several automated methods have been formulated to improve the efficiency of individual learning. These include the use of interactive reference databases and remedial communications skills technology, as well as integrating interactive multimedia and multi-sensory stimuli into the learning process. Other instructional methods monitor the speed of a student's response to prompting or concentration-sensitive behavior. However, all of these learning methods fail in several respects.

The advent of network-based training provides for the mapping of online learning which was previously tedious for students and instructors in traditional settings. But despite improved ability to quantitatively track student progress in online learning situations, there has been a lack of focus with regard to the development of information retention processes after initial evaluation. Although prior learning methods may provide various measurements of student comprehension, such systems do not facilitate ongoing personalized adaptation of the course and testing content to maximize individual retention. Furthermore, prior learning methods often only link failed questions to a narrowly-defined content element. Such learning methods are designed to accommodate static educational content and do not provide links to related, dependent, or pre-requisite topics. Additionally, such learning methods may not allow efficient personalization of a curriculum retention process via customized content, timing, and performance goals. Prior methods may also fail to provide simultaneous support for geographically separated students. Finally, these methods may be limited to specific delivery settings and may require uncommon specialized equipment, such as high performance, expensive audio or video devices.

What is needed is a method of constructing and teaching a curriculum which automatically adapts both review and test content based upon measurable performance results in order to maximize learning for individuals. More particularly, what is needed is a learning method with the capability to automatically adapt, personalize, assess and then re-adapt the curriculum content to meet the needs of the individual student. The learning method should be able to take a virtually unlimited amount of static and/or dynamic educational content with dependent and/or pre-requisite linked topics and present it to the student without reorganizing or rearranging the content. The learning method should provide the ability to link failed questions to both broad and narrow content elements, as desired. Additionally, the learning method should allow efficient personalization of the curriculum with customized content revisions, testing intervals, and performance measurement thresholds. Finally, the learning method should have the flexibility to support a variety of delivery settings and require no specialized equipment.

### SUMMARY OF THE INVENTION

The present invention relates to a method for constructing and teaching a curriculum which automatically adapts both review and test content based upon measurable performance results in order to maximize learning. The method includes the preparation of a plurality of primary course components. Buckets of test questions are prepared and mapped to at least one of the primary course components. For purposes of this discussion, the term “bucket” means a set of similar, interchangeable test questions which are tagged to the same curriculum content. The instructor may present the primary course components by live or network-based teaching methods. The student attends the curriculum and completes a primary course review exercise based on selected test questions. Using pre-determined pass and fail threshold scores, the student's performance with regard to the primary course components is evaluated, and the student will either pass, fail, or enter the Adaptive eLearning Process based on a percentage of correct answers to the selected test questions. If the student passes or fails, no further actions are taken and the method ends. If the student's score falls between the two thresholds, the student will enter the Adaptive eLearning Process.

In the Adaptive eLearning Process, the questions which the student missed are mapped to related primary course components. The method automatically identifies the related content areas and all buckets mapped to those content areas. The method will automatically generate content-based “Adaptive eLearning Components,” meaning all primary course components which are mapped to the test question bucket which contained the missed test question. The Adaptive eLearning Components may be expanded or personalized by the instructor using new web curriculum components, instructor designated components, and/or “knowledge silos,” which are defined to mean sets of information collected from a network-based search for topical information, FAQ (Frequently Asked Questions) informational responses, and/or threaded topical discussions.

After a predetermined interval (which may vary between each review exercise), the student studies the generated Adaptive eLearning Components and then completes an Adaptive eLearning Review Exercise. The phrase “Adaptive eLearning Review Exercise” means an auto-generated, content-based, individualized examination derived from the preselected mapping of the primary course components and the corresponding buckets of test questions. The student is asked questions from all buckets from which the student missed a question on the prior review exercise. Additionally, the student will receive at least one other question from any test bucket which contains a question that the student answered correctly if that test bucket happens to be mapped to the same primary course component to which a missed test bucket question was mapped. Based upon the student's score and the pass/fail thresholds established by the instructor for this exam, the student will either pass or fail the curriculum or continue the Adaptive eLearning Process.

The Adaptive eLearning Process allows the instructor to tag primary course components according to a number of criteria, such as specific content, component relationships, and relative importance. The buckets of questions may be indexed according to their usage in primary and/or review exercises, or for specific primary course components only. The method may be implemented using a variety of solutions such as a network or an intranet. Alternatively, the method may be implemented using a client/server solution.

### BRIEF DESCRIPTION OF THE DRAWINGS

A more complete understanding of the advantages and objects of the present invention may be had by reference to the following detailed description taken in conjunction with the accompanying drawings, wherein:

FIG. 1 is a flow chart indicating the overall sequence of events according to a preferred embodiment of a method for constructing and teaching a curriculum according to the present invention; and

FIG. 2 is a diagram of an exemplary mapping method for Adaptive eLearning Components.

### DETAILED DESCRIPTION OF PRESENTLY PREFERRED EXEMPLARY EMBODIMENTS

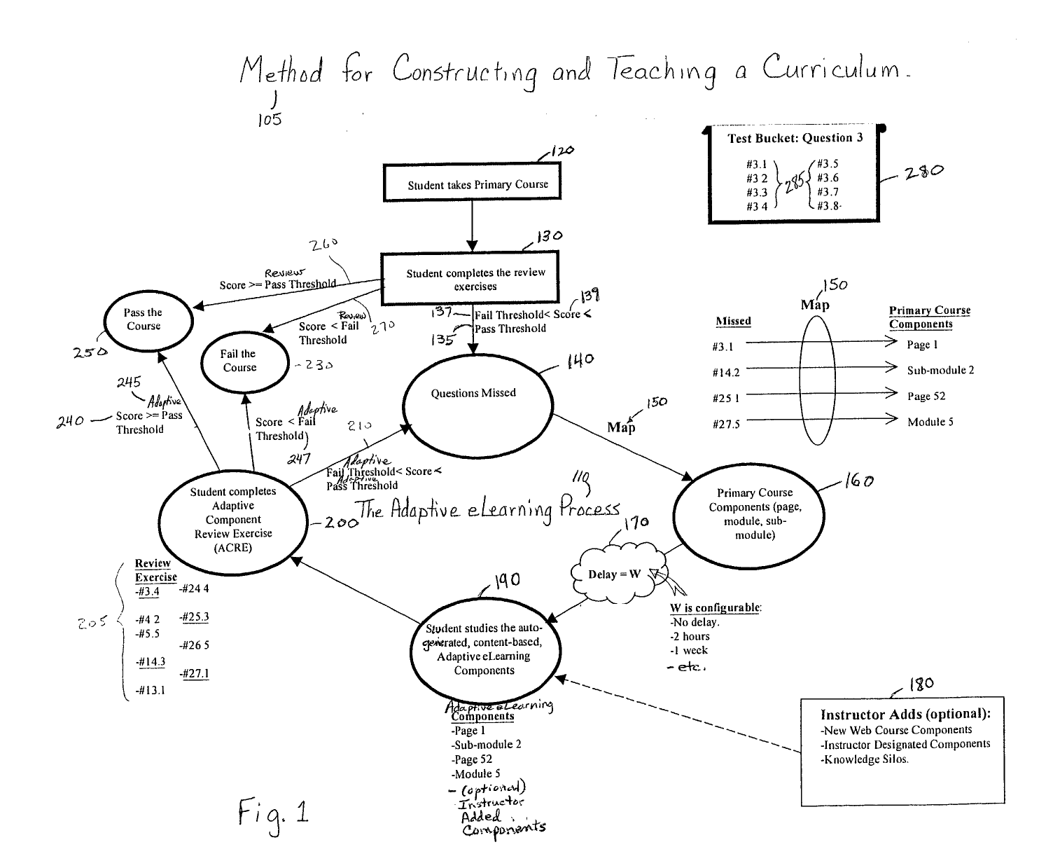

The overall sequence of events for a preferred embodiment of a method for constructing and teaching a curriculum according to the present invention is set forth in the flow chart of FIG. 1. The curriculum construction begins with the selection of a plurality of primary course components 160. These components 160 are created by the instructor using the traditional method of live stand-up classroom lectures, graphics, textbooks, or a network-based authoring and scheduling engine. The instructor may also use a combination of the above methods to prepare customized primary course component content. These components 160 may be formed from a virtually unlimited amount of static or dynamic educational content. The components 160 may be topically linked in that one component may require a pre-requisite, or be a pre-requisite, for another component. The components may be tagged according to instructor-selected criteria such as content, relationship, or qualitative weight. The components 160 may be presented by a variety of delivery methods depending on the number of students and the geographic location of the students and instructor. In one embodiment of the invention, the method can be implemented by simply viewing standard pages over a network or intranet display device. Using a network solution, the method 105 can support a virtually unlimited number of geographically separated students simultaneously. The method 105 can also be implemented using a client/server solution. Additionally, commonly available computer equipment is utilized in this method 105 and no specialized equipment such as highspeed, expensive audio or video devices is required.

The instructor prepares/selects a first plurality of test questions 115 based on the primary course components 160. Then the instructor develops at least one bucket 280 of test questions 285 selected from the first plurality of test questions which are mapped to at least one of the primary course components 160. Each test question 285 is derived from a bucket 280 of similar, interchangeable questions which relate to the same primary course components 160. Each question 285 in the bucket 280 can be interchanged with any other question 285 in the same bucket without altering the scope or breadth of the review exercise. These questions may be indexed by usage in one or more areas, such as the primary course review exercise 130, the Adaptive Component Review Exercise 200, and the primary course components 160.

The instructor prepares a primary course review exercise 130 composed of a set of review questions selected from one or more buckets 280 according to the mapping of the buckets 280 and the primary course 120. The instructor selects a review score pass threshold 135, i.e., a top-end threshold, and a review score fail threshold 137, i.e., a bottom-end threshold, for the primary course review exercise 130. The instructor has the option of setting the review top-end threshold 135 to 100% and setting the review bottom-end threshold 137 to 0% to effectively disengage this feature and require all students to enter the Adaptive eLearning Process 110 until they achieve a score of 100%.

The instructor introduces and teaches the primary course 120 by live classroom teaching and/or network-based teaching. After taking this primary course 120, the student completes the primary course review exercise 130 (i.e., an examination) which is automatically or manually scored.

The curriculum method calculates the percentage of questions in the review exercise 130 which the student answered correctly and compares the student's score 139 with the review top-end threshold 135 and review bottom-end threshold 137 scores established by the instructor for the particular student or content. Based upon this information, one of three events may occur. The student's score 139 may about equal or exceed the review top-end threshold 135 and therefore the student will pass the curriculum 250; with no additional testing required. Alternatively, the student's score 139 may about equal or fall below the review bottom-end threshold 137 and the student will fail the curriculum 230, and no additional testing is performed. If the student's score 139 falls about between the review top-end threshold 135 and review bottom-end threshold 137, the student will enter the Adaptive eLearning Process 110 and receive additional review and testing based upon the mapping of questions missed 140 in the primary review exercise 130.

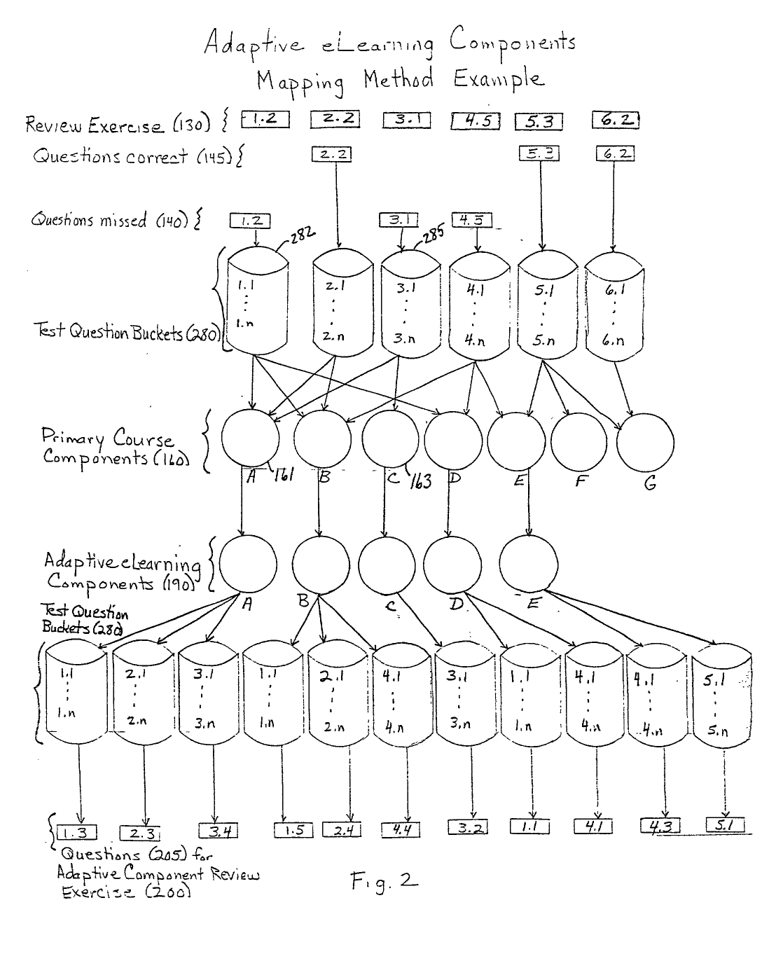

As illustrated in detail in FIG. 2, the questions from the review exercise 130 which the student missed 140 are each mapped to a single test question bucket 280, which is mapped to one or more of the primary course components 160. The method of the Adaptive eLearning Process 110 includes automatic generation of content-based Adaptive eLearning Components 190 which include every primary course component 160 which is mapped to a test bucket 280 containing a missed question 140. Optionally, the instructor may add new material 180 such as new curriculum components, instructor designated components, and/or knowledge silos. After a configurable delay interval 170 established by the instructor, the student studies the Adaptive eLearning Components 190 in preparation for the Adaptive Component Review Exercise 200.

As illustrated in FIG. 2, the questions 205 in the Adaptive Component Review Exercise 200 are based upon the primary course components 160 which are mapped to the questions the student originally missed 140. The Adaptive Component Review Exercise 200 includes at least one question 205 from each test question bucket 280 that contains a question which the student missed 140 in the previous cycle. The student does not see the same question twice unless they have exhausted all the questions in the test question bucket 280. For example, if the student missed question 3.1 from bucket 285 on the first cycle, they might see question 3.4 on the Adaptive Component Review Exercise 200. If we assume that each test question bucket 280 has 8 questions, then the student can miss a question from test question bucket 285 eight times before they will see the same question again.

Additionally, the Adaptive Component Review Exercise 200 may contain questions 205 from test question buckets 280 that the student did not miss on the previous cycle. The reason for this is that each test question bucket 280 containing a missed question 140 is mapped back to one or more primary course components 160. For example, questions missed 140 from test question bucket 285 are mapped to primary course components 161 and 163. Thus, all of the test question buckets 280 which are mapped to any particular primary course component 160 are represented with at least one question 205 on the Adaptive Component Review Exercise 200, thus ensuring well-rounded comprehension of the primary course component 160 material.

Returning to FIG. 1, it can be seen that the student's correctly answered percentage score 240 on the Adaptive Component Review Exercise 200 is compared to the adaptive top-end threshold 245 and adaptive bottom-end threshold 247 established by the instructor for the Adaptive Component Review Exercise 200, as was done in the scoring process of the primary review exercise 130. If the student's score 240 is about equal to or above the adaptive top-end threshold 245, the student passes the curriculum 250 and no further study is required. If the student's score 240 is about equal to or falls below the adaptive bottom-end threshold 247, the student fails the curriculum 230 and no further study is required. However, if the student's score 240 falls approximately between the adaptive top-end threshold 245 and adaptive bottom-end threshold 247, the student continues the Adaptive eLearning Process 110 with the study and completion of newly generated Adaptive eLearning Components 190 and Adaptive Component Review Exercises 200 which are individualized to meet the specific needs of that student. The Adaptive eLearning Process continues until the student's correctly answered percentage score 240 on an Adaptive Component Review Exercise 200 exceeds the adaptive top-end threshold 245, i.e, a passing score. In many cases, a very effective setting for the thresholds is 0% for failing and 100% for passing. This results in all students staying in the Adaptive eLearning process until each has effectively scored 100% on all of the material. This ensures that each student masters all the concepts.

Although preferred embodiments of the method of the present invention have been illustrated in the accompanying Drawings and described in the foregoing Detailed Description, it will be understood that the invention is not limited to the embodiments disclosed, but is capable to numerous rearrangements, modifications and substitutions without departing from the scope of the invention as set forth and defined by the following claims.

What I claim is:

1. A method of constructing a curriculum comprising the steps of:
selecting a plurality of primary course components;
selecting a first plurality of test questions;
developing at least one test question bucket including a set of bucket test questions selected from the first plurality of test questions;
mapping said at least one test question bucket to at least one of said primary course components;
preparing a primary course review exercise comprising a set of review questions selected from said set of bucket test questions; and
selecting a review top-end threshold score and a review bottom-end threshold score for said primary course review exercise.

2. The method of claim 1, further including the step of generating at least one content-based Adaptive eLearning Component.

3. The method of claim 1, further including the step of generating an Adaptive Component Review Exercise including a set of review test questions selected from said first plurality of test questions.

4. The method of claim 3, further including the step of selecting an adaptive top-end threshold score and an adaptive bottom-end threshold score for said Adaptive Component Review Exercise.

5. The method of claim 1, wherein said primary course components are tagged by instructor-selected criteria.

6. The method of claim 5, wherein said instructor-selected criterion is content.

7. The method of claim 5, wherein said instructor-selected criterion is a relationship between said primary course components.

8. The method of claim 5, wherein said instructor-selected criterion is a qualitative weight of said plurality of primary course components.

9. The method of claim 1, wherein said content-based Adaptive eLearning Components include a new network curriculum component.

10. The method of claim 1, wherein said content-based Adaptive eLearning Components include an instructor-designated component.

11. The method of claim 1, wherein said content-based Adaptive eLearning Components include a knowledge silo.

12. The method of claim 1, wherein said first plurality of questions is indexed by said primary course review exercise.

13. The method of claim 1, wherein said first plurality of questions is indexed by said Adaptive Component Review Exercises.

14. The method of claim 1, wherein said first plurality of questions is indexed by said primary course review exercise and said Adaptive Component Review Exercises.

15. The method of claim 1, wherein said first plurality of questions is indexed by said primary course component.

16. A method of teaching a curriculum to a student including a plurality of primary course components mapped to at least one test question bucket including a set of test bucket questions; a primary course review exercise including a set of review questions selected from said first plurality of questions, a top-end threshold score, and a bottom-end threshold score; a content-based Adaptive eLearning Component; and an Adaptive Component Review Exercise comprising the steps of:
presenting the content of said plurality of primary course components to the student;
administering said primary course review exercise to the student;
determining a correctly answered percentage of said set of review questions on said primary course review exercise; and
comparing said correctly answered percentage of said set of review questions to said review top-end and review bottom-end threshold scores to determine whether the student passes the curriculum, fails the curriculum, or enters an Adaptive eLearning Process.

17. The method of claim 16, wherein the Adaptive Component Review Exercise includes a set of adaptive questions selected from said set of test bucket questions, wherein the Adaptive eLearning Process includes the steps of:
(a) selecting a number of review periods;
(b) presenting said content-based Adaptive eLearning Component;
(c) administering said Adaptive Component Review Exercise;
(d) determining the correctly answered percentage of said set of adaptive questions on said Adaptive Component Review Exercise; and
(e) comparing said correctly answered percentage of said set of adaptive questions to said adaptive top-end and adaptive bottom-end threshold scores to determine whether the student passes the curriculum, fails the curriculum, or repeats steps (a)-(d).

18. The method of claim 17, wherein the step of selecting a number of review periods further includes the step of:
selecting a variable delay time period between each one of the selected number of review periods.

19. The method of claim 16, wherein said primary course components are presented by live classroom teaching.

20. The method of claim 16, wherein said primary course components are presented by network-based teaching.

21. The method of claim 16, wherein said primary course components are presented by live classroom teaching and network-based teaching.

22. The method of claim 16, wherein said method of teaching a curriculum is implemented using a network.

23. The method of claim 16, wherein said method of teaching a curriculum is implemented using a client/server.
